(19) United States
(12) Patent Application Publication
(10) Pub. No.: US 2024/0321262 A1
(43) Pub. Date: Sep. 26, 2024

(54) MULTILINGUAL DOMAIN DETECTION USING ONE LANGUAGE RESOURCE

(71) Applicant: Samsung Electronics Co., Ltd., Suwon-si (KR)

(72) Inventors: Tapas Kanungo, Redmond, WA (US); Stephen Walsh, Sunnyvale, CA (US); Preeti Saraswat, Santa Clara, CA (US); Yurii Lozhnevsky, Sunnyvale, CA (US); Nehal Bengre Juraska, Cupertino, CA (US); Qingxiaoyang Zhu, Woodland, CA (US)

(21) Appl. No.: 18/611,411

(22) Filed: Mar. 20, 2024

Related U.S. Application Data
(60) Provisional application No. 63/454,206, filed on Mar. 23, 2023.

(51) Int. Cl. G10L 15/06

(52) U.S. Cl. CPC G10L 15/063

(57) ABSTRACT

A method includes generating, using at least one processing device of an electronic device, a multilingual training corpus including labeled utterances in multiple languages including a first language and a second language. The multilingual training corpus includes at least one utterance that has been translated into the multiple languages. The method also includes fine-tuning, using the at least one processing device, a multilingual language model using the multilingual training corpus.

### CROSS-REFERENCE TO RELATED APPLICATIONS AND PRIORITY CLAIM

This application claims priority under 35 U.S.C. § 119(e) to U.S. Provisional Patent Application No. 63/454,206 filed on Mar. 23, 2023, which is hereby incorporated by reference in its entirety.

### TECHNICAL FIELD

This disclosure relates generally to machine learning systems and processes. More specifically, this disclosure relates to multilingual domain detection using one language resource.

### BACKGROUND

Natural language machine learning systems are becoming more prevalent in the use of consumer electronic devices, such as smart phones and digital voice assistants. Scaling such natural language systems to multiple languages can be challenging. For example, to scale a voice assistant to multiple new target languages, ground truth data for a domain detector must be generated. However, this can be challenging due to the amount of human labeling effort, time, and money required for generating ground truth data in the target languages.

### SUMMARY

This disclosure relates to multilingual domain detection using one language resource.

In a first embodiment, a method includes generating, using at least one processing device of an electronic device, a multilingual training corpus including labeled utterances in multiple languages including a first language and a second language. The multilingual training corpus includes at least one utterance that has been translated into the multiple languages. The method also includes fine-tuning, using the at least one processing device, a multilingual language model using the multilingual training corpus. In another embodiment, a non-transitory machine readable medium includes instructions that when executed cause at least one processor to perform the method of the first embodiment.

In a second embodiment, an electronic device includes at least one processing device configured to generate a multilingual training corpus including labeled utterances in multiple languages including a first language and a second language. The multilingual training corpus includes at least one utterance that has been translated into the multiple languages. The at least one processing device is also configured to fine-tune a multilingual language model using the multilingual training corpus.

In a third embodiment, a method includes receiving, using at least one processing device of an electronic device, an input utterance in a first language. The method also includes applying, using the at least one processing device, a translation model to translate the input utterance into a second language. The method further includes inputting, using the at least one processing device, the translated input utterance to a multilingual language model to predict a domain of the translated input utterance. In addition, the method includes providing, using the at least one processing device, the predicted domain to a user. The multilingual language model is trained using a multilingual training corpus including labeled utterances in multiple languages including the first language and the second language. The multilingual training corpus includes at least one utterance that has been translated into the multiple languages. In another embodiment, an electronic device includes at least one processing device configured to perform the method of the third embodiment. In still another embodiment, a non-transitory machine readable medium includes instructions that when executed cause at least one processor to perform the method of the third embodiment.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device according to this disclosure;

FIG. 2 illustrates an example process for training a multilingual transformer model using one language resource according to this disclosure;

FIGS. 3 and 4 illustrate an example translation operation in the process of FIG. 2 according to this disclosure;

FIG. 5 illustrates an example process for multilingual domain detection using one language resource according to this disclosure;

FIG. 6 illustrates an example method for training a multilingual transformer model using one language resource according to this disclosure; and

FIG. 7 illustrates an example method for multilingual domain detection using one language resource according to this disclosure.

### DETAILED DESCRIPTION

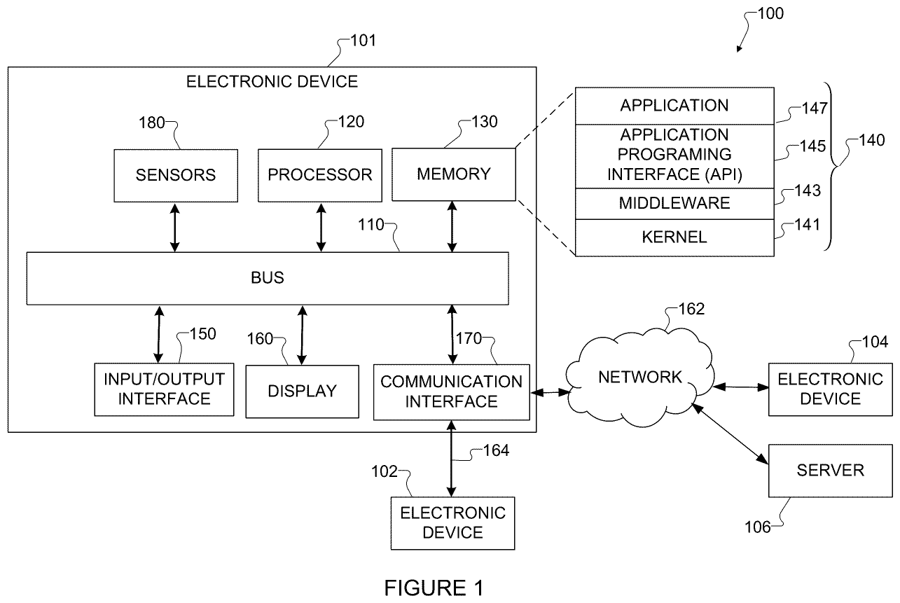

FIGS. 1 through 7, discussed below, and the various embodiments of this disclosure are described with reference to the accompanying drawings. However, it should be appreciated that this disclosure is not limited to these embodiments and all changes and/or equivalents or replacements thereto also belong to the scope of this disclosure.

As discussed above, natural language machine learning systems are becoming more prevalent in the use of consumer electronic devices, such as smart phones and digital voice assistants. Scaling such natural language systems to multiple languages can be challenging. For example, to scale a voice assistant to multiple new target languages, ground truth data for a domain detector must be generated. However, this can be challenging due to the amount of human labeling effort, time, and money required for generating ground truth data in the target languages.

This disclosure provides various techniques for multilingual domain detection using one language resource. As described in more detail below, the disclosed embodiments can generate a corpus of training data in multiple languages given domain labels in one language. The training data corpus can be used to train a multilingual transformer or other multilingual machine learning model. The disclosed embodiments feature a zero-shot machine learning algorithm using multilingual transformers that can predict the domain of an utterance that is in an unseen language. In addition, the disclosed embodiments can help improve a target language domain detector if there are already a few example training utterances in the target language. Note that while some of the embodiments discussed below are described in the context of use in consumer electronic devices (such as smartphones), this is merely one example. It will be understood that the principles of this disclosure may be implemented in any number of other suitable contexts and may use any suitable devices.

FIG. 1 illustrates an example network configuration 100 including an electronic device according to this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described in more detail below, the processor 120 may perform one or more operations for multilingual domain detection using one language resource.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support one or more functions for multilingual domain detection using one language resource as discussed below. These functions can be performed by a single application or by multiple applications that each carry out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an AR wearable device, such as a headset with a display panel or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform one or more operations to support techniques for multilingual domain detection using one language resource.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

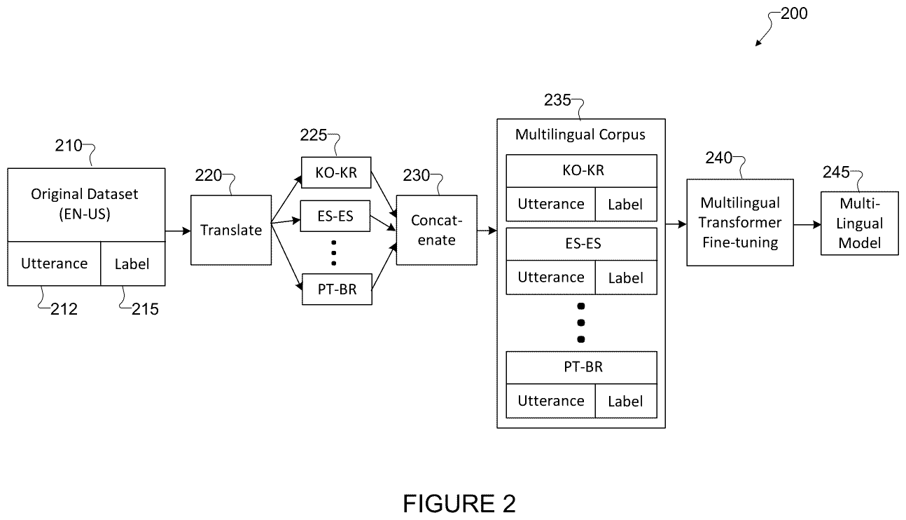

FIG. 2 illustrates an example process 200 for training a multilingual transformer model using one language resource according to this disclosure. For case of explanation, the process 200 is described as being implemented using one or more components of the network configuration 100 of FIG. 1 described above, such as the server 106. However, this is merely one example, and the process 200 could be implemented using any other suitable device(s) (such as the electronic device 101) and in any other suitable system(s).

As shown in FIG. 2, the process 200 includes the server 106 obtaining a training dataset 210 that includes multiple training utterances 212. All of the training utterances 212 are in a particular language associated with a particular locale, such as English in the United States (EN-US) or Spanish in Spain (ES-ES). As used here, locale refers to a combination of language and location, since location often determines language usage and dialect. For example, Canadian French is similar to French as spoken in France, but there are notable differences. Each training utterance 212 includes at least one domain label 215 that associates that training utterance 212 with a domain. Here, the domain is an identifier that indicates a type or subject of information in the training utterance. Example domains can include time, calendar, location, place, person, organization, and the like.

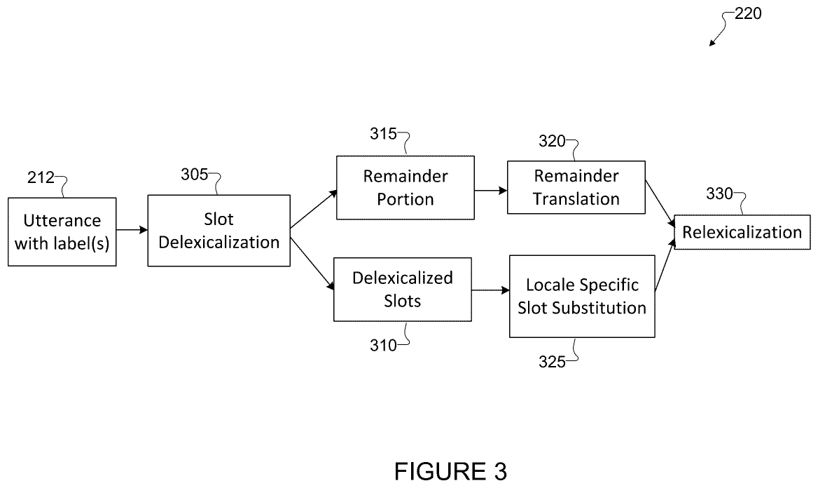

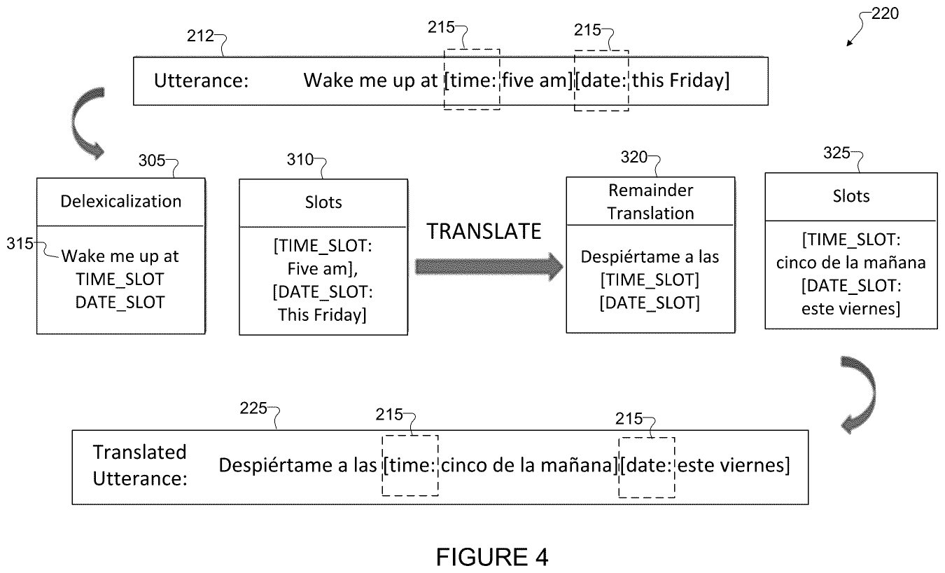

Once the server 106 has obtained the training dataset 210, the server 106 performs a translation operation 220 on the training utterances 212 to generate other translated utterances 225 in other languages. FIGS. 3 and 4 illustrate an example translation operation 220 in the process 200 of FIG. 2 according to this disclosure. In particular, FIG. 3 illustrates various steps performed in the translation operation 220, and FIG. 4 illustrates example data processed during the translation operation 220. In FIG. 4, an example training utterance 212 of “Wake me up at five am this Friday” is shown. This is a training utterance 212 in English that can be translated into one or more other languages, such as Spanish. The example training utterance 212 has been annotated to include two domain labels 215 indicating a time domain and a date domain.

As shown in FIG. 3, in the translation operation 220, the server 106 performs slot delexicalization 305 on the training utterance 212. The slot delexicalization 305 parses the training utterance 212 based on the domain label(s) 215 present in the training utterance 212 and extracts the domain portion(s) of the training utterance 212. The slot delexicalization 305 replaces the domain portion(s) with a slot token (or tag) that indicates the type of slot or domain. This divides the training utterance 212 into one or more delexicalized slots 310 and a remainder portion 315. The server 106 can use any suitable algorithm to perform the slot delexicalization 305. For example, transformer-based models such as BERT can take an utterance and discover where the slots in that utterance might be. The annotations present in the utterance can help the delexicalization algorithm determine the slots 310.

FIG. 4 illustrates the slot delexicalization 305, which divides the example training utterance 212 into two slots 310 (TIME_SLOT and DATE_SLOT) and a remainder portion 315 (“Wake me up at”). In general, the slots 310 represent information in the training utterance 212 that may present challenges for translation to another language. As another example, if a training utterance 212 is “Give me directions to the SAMSUNG experience store,” the portion “SAMSUNG experience store” would be extracted as a slot 310 during slot delexicalization 305 (because SAMSUNG experience store is a place name that may not readily translate to other languages).

After slot delexicalization 305, the server 106 performs translation 320 on the remainder portion 315 to translate the remainder portion 315 into the target language. The server 106 can use any suitable translation tool or algorithm to perform the translation 320, including Internet-based language translation tools. In FIG. 4, the remainder portion 315 “Wake me up at” is translated to Spanish as “Despiértame a las.”

The server 106 also performs a locale-specific slot substitution operation 325 to convert or translate the slots 310 into the target language. In addition, the tags in the translated utterance are replaced with the translated slots. The locale-specific slot substitution operation 325 can use any locale-specific information to convert or translate the slots 310 into the target language. For example, in the training utterance “Give me directions to the SAMSUNG experience store,” the slot for “SAMSUNG experience store” may be converted to “SAMSUNG experience store” because that name may be used in every locale where the store is located. However, if the name of the store is something else in another locale, the slot for “SAMSUNG experience store” would be converted to the other name for that locale. In FIG. 4, the TIME_SLOT for “five am” is converted to “cinco de la mañana,” and the DATE_SLOT for “this Friday” is converted to “este Viernes.” It is noted that the locale-specific slot substitution operation 325 might generate different conversions for different locales, such as those that use a 24-hour clock instead of a 12-hour clock.

The server 106 completes the translation operation 220 by performing relexicalization 330, which reassembles the translated slots 310 and remainder portion 315 into a translated utterance 225 in the target language. In FIG. 4, the translated utterance 225 is “Despiértame a las cinco de la mañana este Viernes.” As shown in FIG. 4, the translated utterance 225 has the same domain labels 215 as the training utterance 212.

Returning to FIG. 2, it can be seen that the server 106 can repeat the translation operation 220 multiple times so that each of the multiple training utterances 212 in the training dataset 210 is translated into multiple translated utterances 225 in multiple target languages (such as Korcan (KO-KR), Spanish (ES-ES), Brazilian Portuguese (PT-BR), and the like). The server 106 performs a concatenation operation 230 to add all of the translated utterances 225 into a multilingual training corpus 235 that includes training utterances 212 in multiple languages.

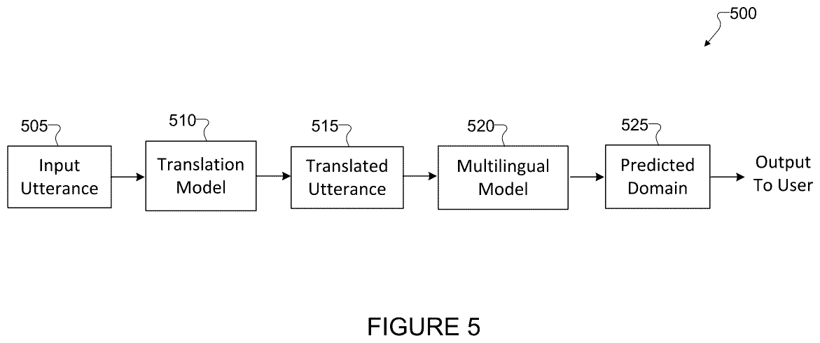

The server 106 can use the multilingual training corpus 235 in a multilingual transformer fine-tuning operation 240. For example, the server 106 can train or fine-tune a multilingual transformer model 245 using the training utterances 212 in the multilingual training corpus 235. Here, the fine-tuning enables the multilingual transformer model 245 to recognize an utterance domain in any of the languages covered by the multilingual training corpus 235. In some embodiments, the fine-tuning takes as input all the training utterances 212 in the multilingual training corpus 235 and simultaneously trains the multilingual transformer model 245. Once fine-tuned, the deep-learned multilingual transformer model 245 can be used for inference during run-time as shown in FIG. 5.

Although FIGS. 2 through 4 illustrate one example of a process 200 for training a multilingual transformer model using one language resource and related details, various changes may be made to FIGS. 2 through 4. For example, while the process 200 is described as involving specific sequences of operations, various operations described with respect to FIGS. 2 through 4 could overlap, occur in parallel, occur in a different order, or occur any number of times (including zero times). Also, the specific operations shown in FIGS. 2 through 4 are examples only, and other techniques could be used to perform each of the operations shown in FIGS. 2 through 4.

FIG. 5 illustrates an example process 500 for multilingual domain detection using one language resource according to this disclosure. For ease of explanation, the process 500 is described as being implemented using one or more components of the network configuration 100 of FIG. 1 described above, such as the server 106. However, this is merely one example, and the process 500 could be implemented using any other suitable device(s) (such as the electronic device 101) and in any other suitable system(s).

As shown in FIG. 5, the server 106 receives an input utterance 505 in a first language, such as English (EN-US) or another suitable language. The server 106 applies a translation model 510 to translate the input utterance 505 into a translated utterance 515 in a second language, such as Spanish (ES-ES) or another suitable language. Here, the translation model 510 can represent any suitable translation model, routine, or algorithm for translating an utterance from one language to another language. In some embodiments, the translation model 510 can represent an Internet-based language translation tool.

After obtaining the translated utterance 515, the server 106 inputs the translated utterance 515 to a multilingual language model 520, which predicts a domain 525 of the translated utterance 515. Here, the multilingual language model 520 has been trained using a training process that includes a multilingual training corpus, such as the multilingual training corpus 235 of FIG. 2. Once the multilingual language model 520 predicts the domain 525 of the translated utterance 515, the predicted domain 525 can be provided or output to a user.

Although FIG. 5 illustrates one example of a process 500 for multilingual domain detection using one language resource, various changes may be made to FIG. 5. For example, while the process 500 is described as involving a specific sequence of operations, various operations described with respect to FIG. 5 could overlap, occur in parallel, occur in a different order, or occur any number of times (including zero times). Also, the specific operations shown in FIG. 5 are examples only, and other techniques could be used to perform each of the operations shown in FIG. 5.

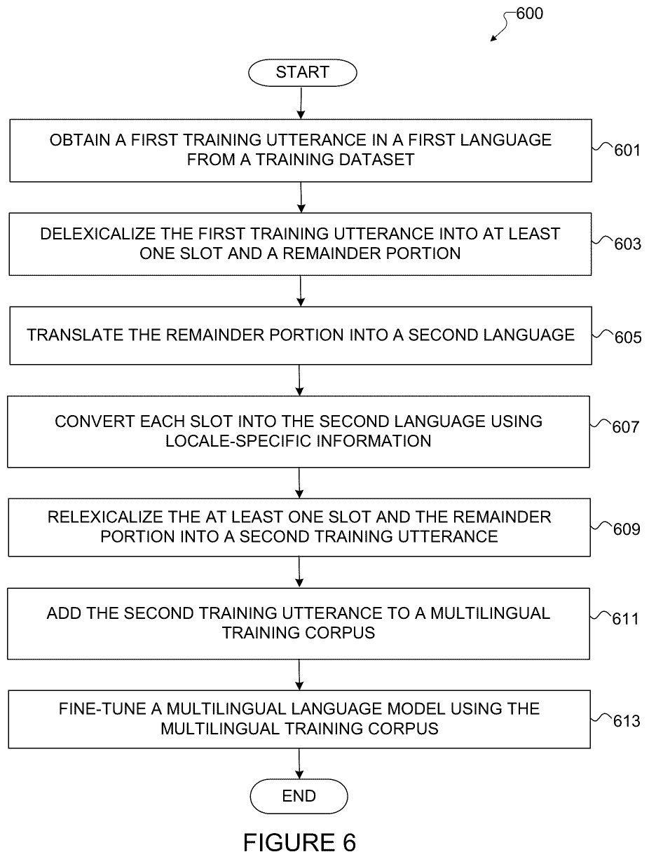

FIG. 6 illustrates an example method 600 for training a multilingual transformer model using one language resource according to this disclosure. For case of explanation, the method 600 shown in FIG. 6 is described as being performed using the server 106 shown in FIG. 1 and the process 200 shown in FIGS. 2 through 4. However, the method 600 shown in FIG. 6 could be used with any other suitable device(s) or system(s) and could be used to perform any other suitable process(es).

As shown in FIG. 6, at step 601, a first training utterance in a first language is obtained from a training dataset. This could include, for example, the server 106 obtaining a training utterance 212, such as is shown in FIG. 2. The first training utterance has at least one domain label. At step 603, the first training utterance is delexicalized into at least one slot and a remainder portion. This could include, for example, the server 106 delexicalizing the training utterance 212 into one or more delexicalized slots 310 and a remainder portion 315, such as is shown in FIG. 3. At step 605, the remainder portion is translated into a second language. This could include, for example, the server 106 translating the remainder portion 315, such as is shown in FIGS. 3 and 4.

At step 607, each of the at least one slot is converted into the second language using locale-specific information. This could include, for example, the server 106 converting the one or more delexicalized slots 310 using the locale-specific slot substitution operation 325, such as is shown in FIGS. 3 and 4. At step 609, the at least one slot and the remainder portion are relexicalized into a second training utterance. This could include, for example, the server 106 performing the relexicalization 330 to generate the translated utterance 225, such as is shown in FIGS. 3 and 4. At step 611, the second training utterance is added to a multilingual training corpus. This could include, for example, the server 106 adding the translated utterance 225 to the multilingual training corpus 235, such as is shown in FIG. 2. At step 613, a multilingual language model is fine-tuned using the multilingual training corpus. This could include, for example, the server 106 performing the multilingual transformer fine-tuning operation 240 on the multilingual transformer model 245, such as is shown in FIG. 2.

Although FIG. 6 illustrates one example of a method 600 for training a multilingual transformer model using one language resource, various changes may be made to FIG. 6. For example, while shown as a series of steps, various steps in FIG. 6 could overlap, occur in parallel, occur in a different order, or occur any number of times (including zero times).

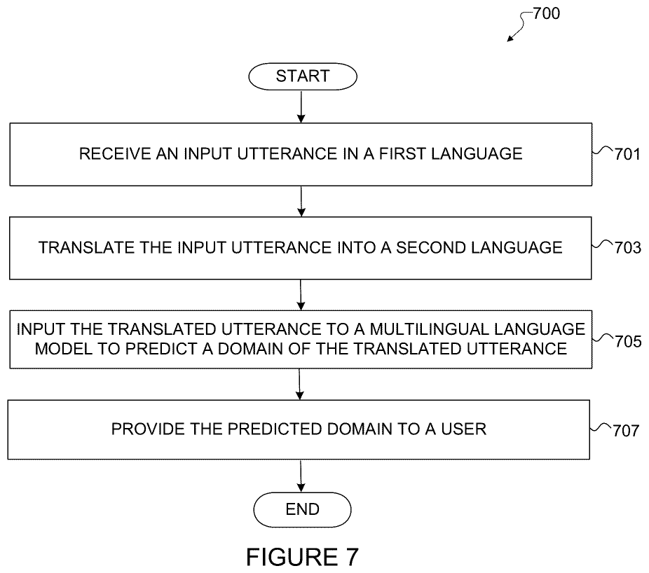

FIG. 7 illustrates an example method 700 for multilingual domain detection using one language resource according to this disclosure. For ease of explanation, the method 700 shown in FIG. 7 is described as being performed using the server 106 shown in FIG. 1 and the process 500 shown in FIG. 5. However, the method 700 shown in FIG. 7 could be used with any other suitable device(s) or system(s) and could be used to perform any other suitable process(es).

As shown in FIG. 7, at step 701, an input utterance is received in a first language. This could include, for example, the server 106 receiving an input utterance 505. At step 703, a translation model is applied to translate the input utterance into a second language. This could include, for example, the server 106 applying the translation model 510 to translate the input utterance 505 into a translated utterance 515 in a second language. At step 705, the translated input utterance is input to a multilingual language model to predict a domain of the translated input utterance. This could include, for example, the server 106 inputting the translated utterance 515 to a multilingual language model 520 to predict a domain 525 of the translated utterance 515. At step 707, the predicted domain is provided to a user. This could include, for example, the server 106 outputting the predicted domain 525 to a user.

Although FIG. 7 illustrates one example of a method 700 for multilingual domain detection using one language resource, various changes may be made to FIG. 7. For example, while shown as a series of steps, various steps in FIG. 7 could overlap, occur in parallel, occur in a different order, or occur any number of times (including zero times).

The disclosed embodiments are suitable for a wide variety of use cases. For instance, the disclosed embodiments enable any suitable consumer electronic device (such as a person's smartphone, smart television, tablet computer, or the like) to have a voice assistant that can identify an utterance domain in multiple languages, even languages where there is little or no labeled training data. The voice assistant can use a single model that has been trained using a training corpus that includes training data in multiple languages. The disclosed training corpus can also save significant computational resources at runtime, including reduced processor and memory usage.

Note that the operations and functions shown in or described with respect to FIGS. 2 through 7 can be implemented in an electronic device 101, 102, 104, server 106, or other device(s) in any suitable manner. For example, in some embodiments, the operations and functions shown in or described with respect to FIGS. 2 through 7 can be implemented or supported using one or more software applications or other software instructions that are executed by the processor 120 of the electronic device 101, 102, 104, server 106, or other device(s). In other embodiments, at least some of the operations and functions shown in or described with respect to FIGS. 2 through 7 can be implemented or supported using dedicated hardware components. In general, the operations and functions shown in or described with respect to FIGS. 2 through 7 can be performed using any suitable hardware or any suitable combination of hardware and software/firmware instructions.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
generating, using at least one processing device of an electronic device, a multilingual training corpus comprising labeled utterances in multiple languages including a first language and a second language, the multilingual training corpus comprising at least one utterance that has been translated into the multiple languages; and
fine-tuning, using the at least one processing device, a multilingual language model using the multilingual training corpus.

2. The method of claim 1, wherein generating the multilingual training corpus comprises:
obtaining a first training utterance in the first language from a training dataset, the first training utterance having at least one domain label;
delexicalizing the first training utterance into at least one slot and a remainder portion;
translating the remainder portion into the second language;
converting each of the at least one slot into the second language using locale-specific information;
relexicalizing the at least one slot and the remainder portion into a second training utterance; and
adding the second training utterance to the multilingual training corpus.

3. The method of claim 2, further comprising:
repeating the obtaining, delexicalizing, translating, converting, relexicalizing, and adding for multiple training utterances and multiple second languages.

4. The method of claim 2, wherein:
the second language is associated with a specific locale; and
the locale-specific information corresponds to the specific locale.

5. The method of claim 2, wherein the second training utterance has the same at least one domain label as the first training utterance.

6. The method of claim 2, wherein the remainder portion is translated into the second language using an Internet-based language translation tool.

7. The method of claim 1, wherein the multilingual language model is configured to predict a domain of an input utterance that has been translated from the first language into the second language.

8. An electronic device comprising:
at least one processing device configured to:
generate a multilingual training corpus comprising labeled utterances in multiple languages including a first language and a second language, the multilingual training corpus comprising at least one utterance that has been translated into the multiple languages; and
fine-tune a multilingual language model using the multilingual training corpus.

9. The electronic device of claim 8, wherein, to generate the multilingual training corpus, the at least one processing device is configured to:
obtain a first training utterance in the first language from a training dataset, the first training utterance having at least one domain label;
delexicalize the first training utterance into at least one slot and a remainder portion;
translate the remainder portion into the second language;
convert each of the at least one slot into the second language using locale-specific information;
relexicalize the at least one slot and the remainder portion into a second training utterance; and
add the second training utterance to the multilingual training corpus.

10. The electronic device of claim 9, wherein the at least one processing device is further configured to repeat the obtain, delexicalize, translate, convert, relexicalize, and add operations for multiple training utterances and multiple second languages.

11. The electronic device of claim 9, wherein:
the second language is associated with a specific locale; and
the locale-specific information corresponds to the specific locale.

12. The electronic device of claim 9, wherein the second training utterance has the same at least one domain label as the first training utterance.

13. The electronic device of claim 9, wherein the at least one processing device is configured to translate the remainder portion into the second language using an Internet-based language translation tool.

14. The electronic device of claim 8, wherein the multilingual language model is configured to predict a domain of an input utterance that has been translated from the first language into the second language.

15. A method comprising:
receiving, using at least one processing device of an electronic device, an input utterance in a first language;
applying, using the at least one processing device, a translation model to translate the input utterance into a second language;
inputting, using the at least one processing device, the translated input utterance to a multilingual language model to predict a domain of the translated input utterance; and
providing, using the at least one processing device, the predicted domain to a user;
wherein the multilingual language model is trained using a multilingual training corpus comprising labeled utterances in multiple languages including the first language and the second language, the multilingual training corpus comprising at least one utterance that has been translated into the multiple languages.

16. The method of claim 15, wherein the multilingual training corpus is generated by:
obtaining a first training utterance in the first language from a training dataset, the first training utterance having at least one domain label;
delexicalizing the first training utterance into at least one slot and a remainder portion;
translating the remainder portion into the second language;
converting each of the at least one slot into the second language using locale-specific information;
relexicalizing the at least one slot and the remainder portion into a second training utterance; and
adding the second training utterance to the multilingual training corpus.

17. The method of claim 16, wherein the multilingual training corpus is further generated by repeating the obtaining, delexicalizing, translating, converting, relexicalizing, and adding for multiple training utterances and multiple second languages.

18. The method of claim 16, wherein:
the second language is associated with a specific locale; and
the locale-specific information corresponds to the specific locale.

19. The method of claim 16, wherein the second training utterance has the same at least one domain label as the first training utterance.

20. The method of claim 16, wherein the remainder portion is translated into the second language using an Internet-based language translation tool.
